(19) United States
(12) Patent Application Publication
(10) Pub. No.: US 2008/0036763 A1
(43) Pub. Date: Feb. 14, 2008

(54) METHOD AND SYSTEM FOR COMPUTER GRAPHICS WITH OUT-OF-BAND (OOB) BACKGROUND

(75) Inventors: Cheng-Che Chen, Taipei Hsien (TW); Chan-Hung Su, Kaohsiung City (TW); Yueh-Wei Hu, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/766,240

(22) Filed: Jun. 21, 2007

Related U.S. Application Data
(60) Provisional application No. 60/821,829, filed on Aug. 9, 2006.
(60) Provisional application No. 60/826,091, filed on Sep. 19, 2006.

(51) Int. Cl. G06T 15/40

(52) U.S. Cl. 345/422

(57) ABSTRACT

An embodiment of a method for computer graphics with out-of-band (OOB) background comprises the following steps. A 2D OOB background image is provided. A 3D entity is provided. A 2D foreground image is generated by rendering the 3D entity. A 2D display image is generated according to the 2D background image and the 2D foreground image. The 2D display image is displayed on a display device.

### CROSS REFERENCE TO RELATED APPLICATIONS

This application claims priority of U.S. Provisional Patent Application Ser. No. 60/821,829, filed Aug. 8, 2006 and Ser. No. 60/826,091, filed Sep. 19, 2006. The contents of the provisional applications are hereby incorporated by reference.

### BACKGROUND

The invention relates to computer graphics, and in particular to methods and systems for computer graphics with out-of-band (OOB) background.

Conventional computer graphics systems manipulate and render 3D objects (comprising vertices coordinates, texture coordinates . . . , etc) to a frame buffer. 3D graphics programs allow objects to be created on an X-Y-Z scale (width, height, depth). 3D entities can be rotated and viewed from all angles as well as be scaled larger or smaller. 3D entities also allow lighting to be applied automatically in the rendering stage. Conventional 3D graphics, however, do not provide ability to include OOB background when rendering 3D entities.

### SUMMARY

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

An embodiment of a method for computer graphics with out-of-band (OOB) background comprises the following steps. A 2D OOB background image is provided. A 3D entity is provided. A 2D foreground image is generated by rendering the 3D entity. A 2D display image is generated according to the 2D background image and the 2D foreground image. The 2D display image is displayed on a display device.

An embodiment of a system for computer graphics with OOB background comprises a display device, a loading unit, a scene graph renderer, and a display controller. The loading unit acquires a 2D OOB background image and a 3D entity. The scene graph renderer generates a 2D foreground image by rendering the 3D entity, and generates a 2D display image according to the 2D background image and the 2D foreground image. The display controller directs the display device to display the generated 2D display image.

An embodiment of a system for computer graphics with OOB background comprises a display device, a loading unit, a scene graph renderer, and a display controller. The loading unit acquires at least two 2D OOB background images and a 3D entity. The scene graph renderer generates a 2D foreground image by rendering the 3D entity, determines one of the 2D OOB background image according to current time, and generates a 2D display image according to the determined 2D background image and the 2D foreground image. The display controller directs the display device to display the generated 2D display image.

### BRIEF DESCRIPTION OF DRAWINGS

The invention can be more fully understood by reading the subsequent detailed description and examples with references made to the accompanying drawings, wherein:

FIG. 1 is a diagram illustrating two process stages for computer graphics with out-of-band (OOB) background;

FIG. 2 is a diagram illustrating generation of a display image with reference to the described stages;

FIG. 3 is a diagram of an embodiment of a system for computer graphics with OOB background employed in the loading stage;

FIG. 4 is a flowchart illustrating an embodiment of a method for computer graphics with OOB background, employed by a loading unit during the loading stage;

FIG. 5 is a diagram illustrating the data structure of an embodiment of a 3D rendering file;

FIG. 6 is a diagram of an embodiment of a system for computer graphics with OOB background employed in the rendering stage;

FIG. 7 is a flowchart illustrating an embodiment of a method for computer graphics with OOB background, employed by a scene graph renderer during the rendering stage;

FIG. 8 is a diagram illustrating embodiments of animated OOB background images;

FIG. 9 is a diagram of an embodiment of a system for computer graphics with OOB background employed in the rendering stage; and

FIG. 10 is a flowchart illustrating an embodiment of a method for computer graphics with OOB background, employed by a scene graph renderer during the rendering stage.

### DETAILED DESCRIPTION

One or more specific embodiments of the invention are described below. In an effort to provide a concise description of these embodiments, not all features of an actual implementation are described in the specification. It should be appreciated that in the development of any such actual implementation, as in any engineering or design project, numerous implementation-specific decisions must be made to achieve specific developer goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

In the following detailed description, reference is made to the accompanying drawings which form a part hereof, shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the invention. The following detailed description is, therefore, not to be taken in a limiting sense. The leading digit(s) of reference numbers appearing in the figures corresponds to the figure number, with the exception that the same reference number is used throughout to refer to an identical component which appears in multiple figures. It should be understood that the many of the elements described and illustrated throughout the specification are functional in nature and may be embodied in one or more physical entities or may take other forms beyond those described or depicted.

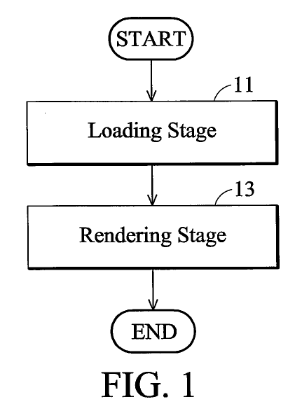

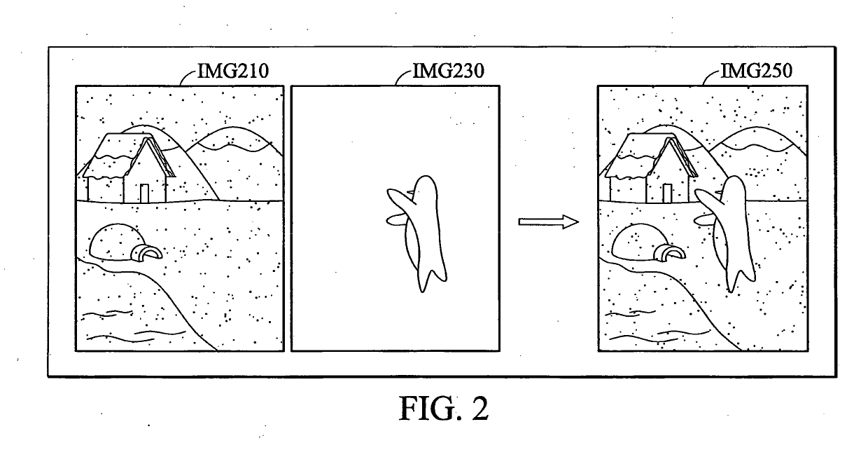

FIG. 1 is a diagram illustrating two process stages for computer graphics with out-of-band (OOB) background. OOB background comprising one or more 2D OOB background images is not included in typical specifications for 3D graphics rendering. It is to be understood that conventional computer graphics engines generate 2D display images by only rendering 3D entities. In a loading stage 11, information regarding OOB is provided, and an OOB background image is generated or acquired according to the provided information and is stored in memory for subsequent rendering. The OOB background image may comfort to the portable network graphics (PNG), graphics interchange format (GIF), or JPEG specification, or others. In a rendering stage 13, the OOB background image is retrieved from the memory and is duplicated in a frame buffer, and subsequently, a foreground image is generated by rendering 3D entities and is stored in the frame buffer to form a display image. FIG. 2 is a diagram illustrating generation of a display image with reference to the described stages. In the loading stage 11, information regarding OOB background is provided, and an OOB background image IMG210 illustrating a scene of an ice field is accordingly generated and stored in memory as an OOB background image. In the rendering stage 13, the OOB background image 210 is retrieved and duplicated in a frame buffer, and subsequently, a foreground image IMG230 illustrating a standing penguin is generated by rendering 3D entities, and is insert into the OOB background image IMG210 of the frame buffer to form a display image IMG250 illustrating a penguin standing on the ice field.

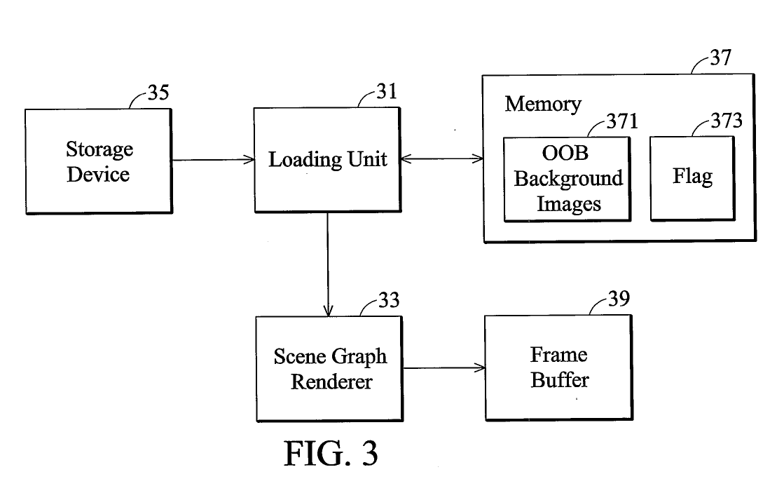

FIG. 3 is a diagram of an embodiment of a system for computer graphics with OOB background employed in the loading stage 11 (FIG. 1), comprising a loading unit 31, a scene graph renderer 33, a storage device 35, memory 37, and a frame buffer 39. The storage device 35 may be a hard drive, magnetic drive, optical drive, portable drive, or nonvolatile memory drive. The storage device 35 and associated computer-readable media thereof (if required) provide nonvolatile storage of a 3D rendering file utilized in 3D graphics rendering. The 3D rendering file describes information regarding OOB background, 3D entities, texture images for applying to 3D entities, or others. The memory 37 may be dynamic random access memory (RAM), synchronous dynamic random access memory (SDRAM), static random access memory (SRAM), or others, and provides volatile storage of one or more OOB background images and foreground images. The frame buffer 39 holds a frame of data for outputting to a display device, such as a supertwisted nematic liquid-crystal display (STN-LCD), a thin film transistor liquid-crystal display (TFT-LCD), an organic light emitting device (OLED), and the similar. The frame buffer size is typically the size of the maximum image that can be displayed on the display device. The frame buffer 37 holds a display image while the display image is being “painted” on the display device. Details of the loading unit 31 and the scene graph renderer 33 are described in the following paragraphs, and briefly described herein.

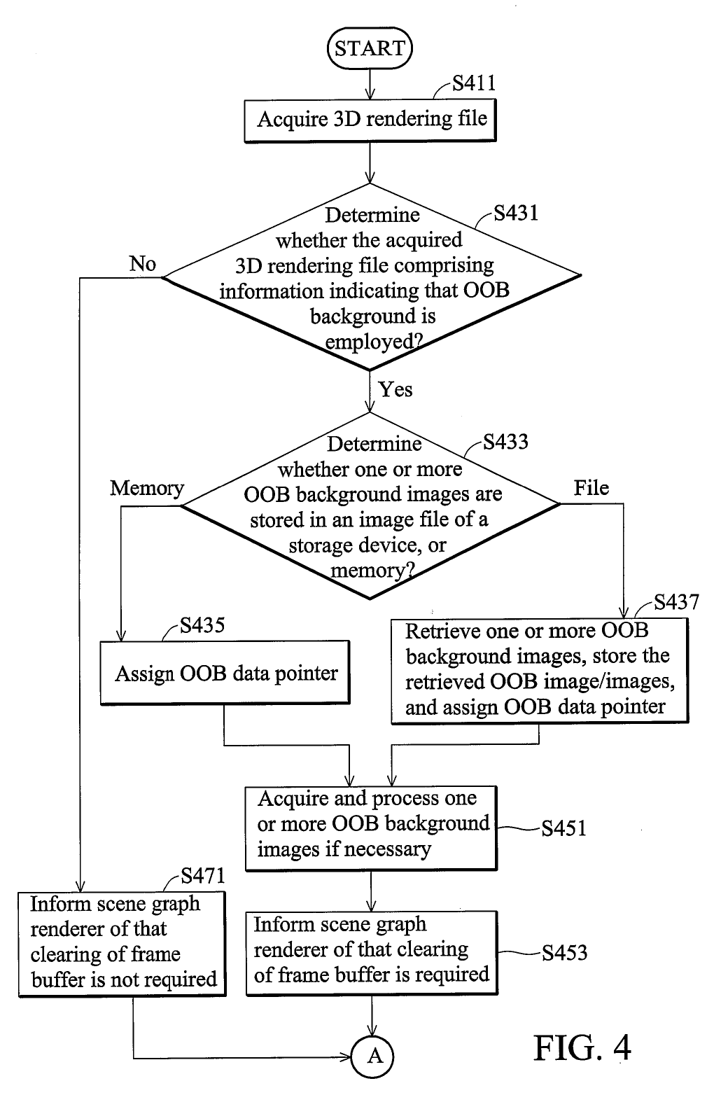

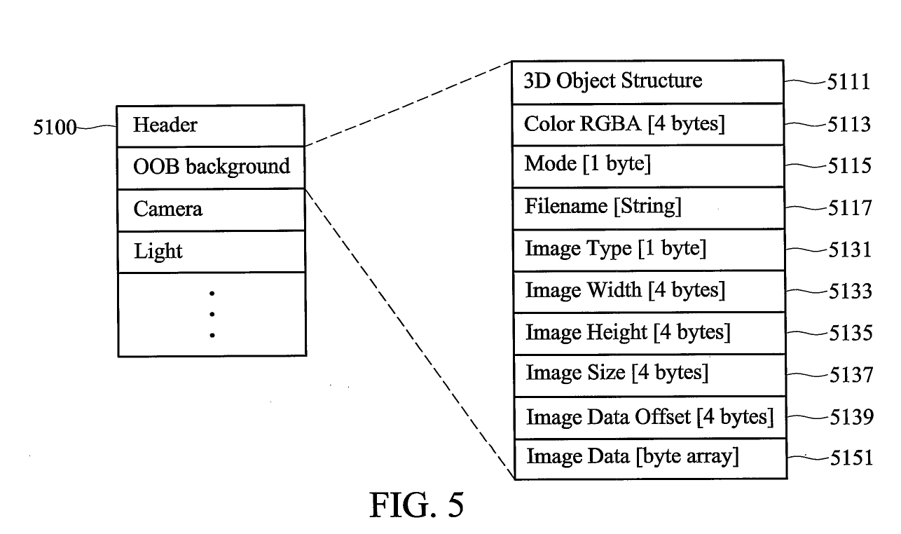

FIG. 4 is a flowchart illustrating an embodiment of a method for computer graphics with OOB background, employed by the loading unit 31 (FIG. 3) during the loading stage 11 (FIG. 1). In step S411, a 3D rendering file is acquired from the storage device 35 (FIG. 3), and the acquired file is stored in the memory 37 (FIG. 3). FIG. 5 is a diagram illustrating the data structure of an embodiment of a 3D rendering file 5100. A OOB background area of the 3D rendering file 5100 further comprises ten fields: 3D object structure 5111; color RGBA of 4 bytes 5113; mode of 1 byte 5115; filename of a string 5117; image type of 1 byte 5131; image width of 4 bytes 5133; image height of 4 bytes 5135; image size of 4 bytes 5137; image data offset of 4 bytes 5139; and image data of a byte array 5151. The 3D object structure field 5111 provides an object type property containing a value “OOB-background” indicating that this 3D object is related to OOB background. The OOB background field may describe OOB background with a single color value, such as “red”, “blue”, “pink”, and the similar, one or more OOB background images, or an external link to an image file, such as “.png”, “.gif”, “.jpg”, and the similar. When describing OOB background image with a single color value, the mode field 5115 records information indicating internal OOB background, and the color RGBA field 5113 records the specific color value. When describing OOB background image with one or more OOB background images, the mode field 5115 records information indicating internal OOB background, the image type, width, height and size fields 5131 to 5137 record profile data of one or more OOB images, and the image data field 5151 records actual image data. When describing OOB background image with an external link to an image file, the mode field 5115 records information indicating external OOB image, and the filename field 5117 records a filename of an image file storing OOB background.

Referring to FIG. 4, in step S431, it is determined whether the acquired 3D rendering file comprising information indicating that OOB background is employed. The determination may be achieved by inspecting whether a value of an object type property is “OOB_background”. If so, the process proceeds to step S433, otherwise, to step S471. In step S471, the loading unit 31 (FIG. 3) informs the scene graph renderer 33 (FIG. 3) of that clearing of the frame buffer 39 (FIG. 3) is required. The loading unit 31 may modify a clear flag 371 (FIG. 3) with “true” to indicate clearing of the frame buffer 39. Thereafter, the scene graph renderer 33 clears the frame buffer 39 when detecting that the clear flag 371 is “true”. In step S433, it is determined whether one or more OOB background images are stored in an image file of the storage device 35 (FIG. 3), or the memory 37. The determination may be achieved by inspecting whether the mode field 5115 (FIG. 5) records information indicating internal or external OOB background. It is determined that one or more OOB background images are stored in an image file when the mode field 5115 (FIG. 5) records information indicating external OOB background, and the image data field 5151 records actual image data. It is determined that one or more OOB background images are stored in memory when the mode field 5115 (FIG. 5) records information indicating internal OOB background. The process proceeds to step S437 when the OOB background image/images is/are stored in an image file, otherwise, to step S435. In step S435, an OOB data pointer is assigned to point an address of the beginning of a region storing the OOB background image/images for subsequent OOB background image acquisition. In an embodiment, an OOB data pointer is assigned to point an address of the beginning of the image data field 5151 (FIG. 5) of the memory 37. In another embodiment, an OOB data pointer is assigned to point a begin address of a region of read only memory (ROM), storing one or more OOB background images. In step S437, one or more OOB background images are retrieved from the image file according to the content of the filename field 5117 (FIG. 5), the retrieved OOB image/images is/are stored in the memory 37, and an OOB data pointer is assigned to point an address of the memory 37, indicating the beginning of a region storing the newly retrieved OOB background image/images, for subsequent OOB background image acquisition. In step S451, one or more OOB background images are acquired according to the OOB data pointer and are processed if necessary. The OOB background image/images may be enlarged or reduced to fit the storage space of the frame buffer 39 (FIG. 3). The OOB background image/images may be decompressed when OOB background image/images is/are in a compress format, such as JPEG, and the similar. In step S453, the loading unit 31 informs the scene graph renderer 33 of that clearing of the frame buffer 39 is not required. The loading unit 31 may modify a clear flag 371 (FIG. 3) with “false” to indicate no clearing of the frame buffer 39. Note that the OOB background image is not generated by rendering any 3D entities with the scene graph renderer 33.

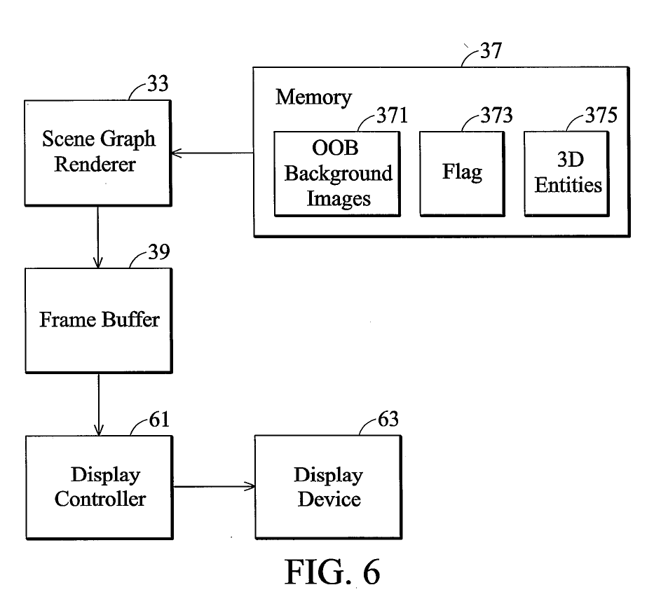

FIG. 6 is a diagram of an embodiment of a system for computer graphics with OOB background employed in the rendering stage 13 (FIG. 1), comprising the scene graph renderer 33, the memory 37, the frame buffer 39, a display controller 61, and a display device 63. The memory 37 further stores data of 3D entities 375, such as triangles, polygons, rectangles, or others. The display controller 61 directs the display device 63, such as a STN-LCD, a TFT-LCD, an OLED display, and the similar, to display the content of the frame buffer 39. Details of the scene graph renderer 33 are described in the following paragraphs, and briefly described herein.

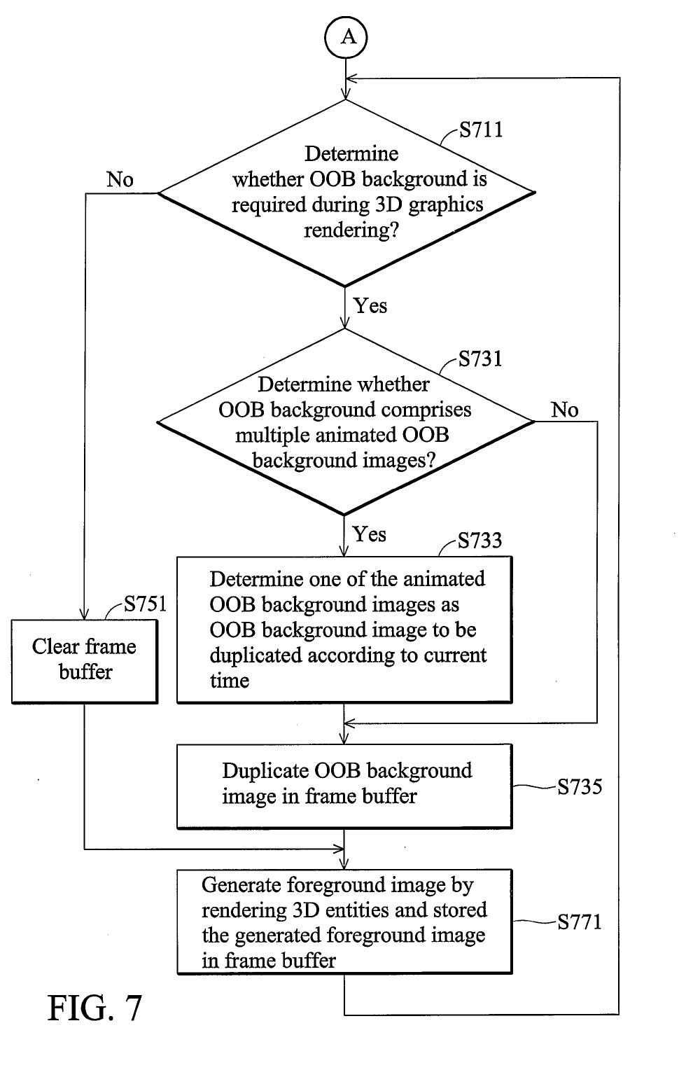

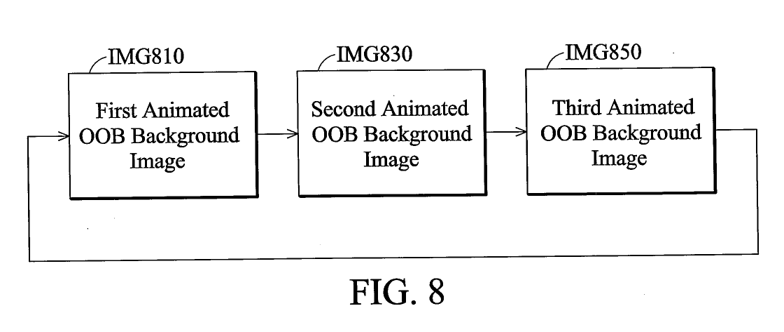

FIG. 7 is a flowchart illustrating an embodiment of a method for computer graphics with OOB background, employed by the scene graph renderer 33 (FIG. 6) during the rendering stage 13 (FIG. 1). Note that this embodiment is employed in a hardware environment comprising single frame buffer. In step S711, it is determined whether OOB background is required during 3D graphics rendering. The determination may be achieved by inspecting the clear flag 371. It is determined that OOB background is required when the clear flag 371 is “false”. It is determined that OOB background is not required when the clear flag 371 is “true”. If so, the process proceeds to step S731, otherwise, to step S751. In step S751, the frame buffer 39 (FIG. 6) is cleared to avoid the intervention of a previous display image. In step S731, it is determined whether OOB background comprises multiple animated OOB background images. The determination may be achieved by inspecting whether the image type field 5131 (FIG. 5) stores information regarding an animated image file, such as a GIF file, and the similar, determining a quantity of the animated OOB background images according to values of image width, height and size fields 5133 to 5137 (FIG. 5). FIG. 8 is a diagram illustrating embodiments of animated OOB background images IMG810 to IMG850. The animated OOB background images are sequentially and cyclically duplicated in the frame buffer 39. That is, at a particular time, one of animated OOB background images is selected and duplicated in the frame buffer 39, as a current OOB background image. In step S733, one of the animated OOB background images is determined as an OOB background image to be duplicated according to current time. In step S735, the determined OOB background image is duplicated in the frame buffer 39. In step S771, a foreground image is generated by rendering 3D entities 375 (FIG. 6) and is stored in the frame buffer 37. It is to be understood that a portion of the stored OOB background image may be overwritten with all or a portion of the generated foreground image, or all or a portion of the stored background image may be blended in a portion of the stored OOB background image in order to form a display image to be outputted to the display device 63. Those skilled in the art may perform well-known methods, such as vertex processing, clipping, primitive assembly, triangle setup, rasterization, occlusion culling, parameter interpolation, pixel shader, or others, to render 3D entities 375. In some embodiments, operations of step S451 (FIG. 4) during the loading stage may be omitted, and these omitted operations may be executed between steps S733 and S735 during the rendering stage if necessary.

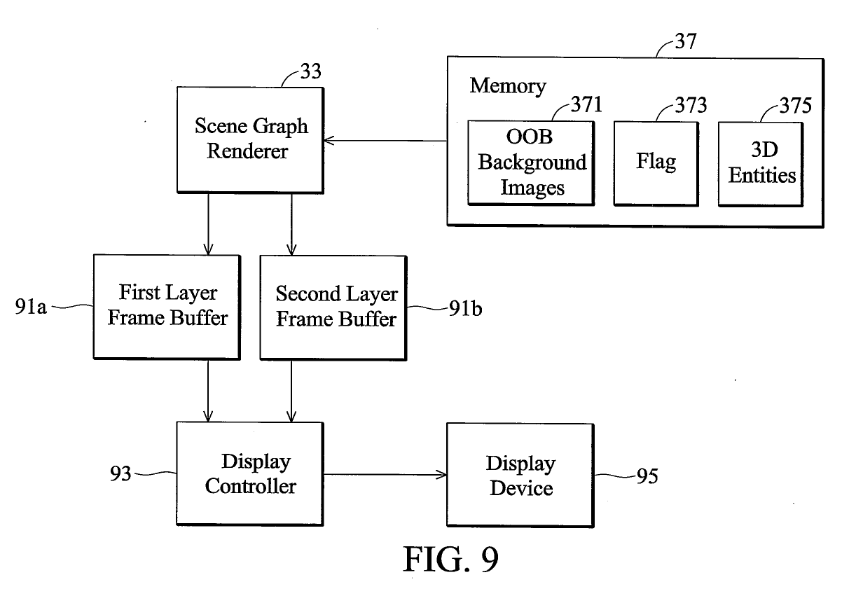

FIG. 9 is a diagram of an embodiment of a system for computer graphics with OOB background employed in the rendering stage 13 (FIG. 1), comprising the scene graph renderer 33, the memory 37, first and second layer frame buffers 91a and 91b, a display controller 93, and a display device 95. The memory 37 further stores data of 3D entities 375, such as triangles, polygons, rectangles, or others. The first layer frame buffer 91a holds an OOB background image, and the second layer frame buffer 91b holds an OOB foreground image for outputting to the display device 95, such as a supertwisted nematic liquid-crystal display (STN-LCD), a thin film transistor liquid-crystal display (TFT-LCD), and the similar. Sizes of both the first and second layer frame buffer 91a and 91b are typically the size of the maximum image that can be displayed on the display device 95. The first and second layer frame buffer 91a and 91b hold OOB background and foreground images while a corresponding display image is being “painted” on the display device 95 via the display controller 93. Details of the scene graph renderer 33 are described in the following paragraphs, and briefly described herein.

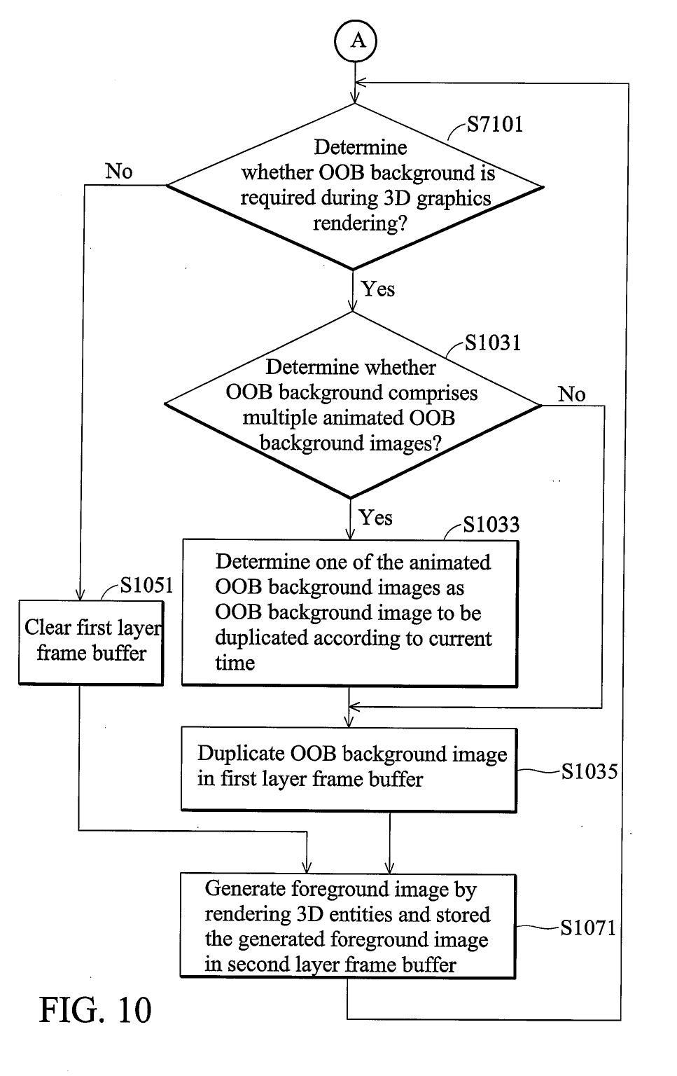

FIG. 10 is a flowchart illustrating an embodiment of a method for computer graphics with OOB background, employed by the scene graph renderer 33 (FIG. 9) during the rendering stage 13 (FIG. 1). Note that this embodiment is employed in a hardware environment comprising two layer frame buffers. In step S1011, it is determined whether OOB background is required during 3D graphics rendering. The determination may be achieved by inspecting the clear flag 371. Detailed examples of the determination may follow the description of step S711 (FIG. 7). If so, the process proceeds to step S1031, otherwise, to step S1051. In step S1051, the first layer frame buffer 91a (FIG. 9) is cleared to avoid the intervention of a previous background image. In step S1031, it is determined whether OOB background comprises multiple animated OOB background images. Detailed examples of the determination may follow the description of step S731 (FIG. 7). In step S1033, one of the animated OOB background images is determined as an OOB background image to be duplicated according to current time. In step S1035, the determined OOB background image is duplicated in the first layer frame buffer 91a. In step S1071, a foreground image is generated by rendering 3D entities 375 (FIG. 9) and is stored in the second layer frame buffer 91b (FIG. 9). Those skilled in the art may perform well-known methods, such as vertex processing, clipping, primitive assembly, triangle setup, rasterization, occlusion culling, parameter interpolation, pixel shader, or others, to render 3D entities 375. It is to be understood that the display controller 93 may overwrite a portion of the OOB background image from the first layer frame buffer 91a with all or a portion of the foreground image from the second layer frame buffer 91b, or blend all or a portion of the foreground image from the second layer frame buffer 91b in a portion of the OOB background image from the first layer frame buffer 91a when both layer frame buffers 91a and 91b hold images to be displayed. It is to be understood that the display controller 93 may directly output the foreground image from the second layer frame buffer 91b to the display device 95 when only second layer frame buffer 91b holds an image to be displayed. In some embodiments, operations of step S451 (FIG. 4) during the loading stage may be omitted, and these omitted operations may be executed between steps S1033 and S1035 during the rendering stage if necessary. Those skilled in the art will recognize that the disclosed OOB background images, the generated foreground images and display images are 2D bitmapped images.

Methods and systems of the invention, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for computer graphics with out-of-band (OOB) background, comprising:
providing a 2D OOB background image;
providing a 3D entity;
generating a 2D foreground image by rendering the 3D entity;
generating a 2D display image according to the 2D background image and the 2D foreground image; and
displaying the 2D display image on a display device.

2. The method of claim 1, wherein the 2D OOB background image is directly acquired from an image file or memory.

3. The method of claim 1, wherein the 2D OOB background image is enlarged or reduced to fit storage space of a frame buffer.

4. The method of claim 1, wherein the 2D OOB background image is decompressed.

5. The method of claim 1, further comprising:
acquiring a 3D rendering file; and
acquiring the 2D OOB background image from the 3D rendering file.

6. The method of claim 1, further comprising:
acquiring a 3D rendering file; and
acquiring a filename of an image file comprising the 2D OOB background image from the 3D rendering file; and
acquiring the 2D OOB background image from a storage device according to the acquired filename.

7. The method of claim 1, wherein a portion of the 2D OOB background image is overwritten with all or a portion of the 2D foreground image to generate the 2D display image.

8. The method of claim 1, wherein all or a portion of the 2D foreground image is blended in a portion of the 2D OOB background image to generate the 2D display image.

9. A system for computer graphics with out-of-band (OOB) background, comprising:
a display device;
a loading unit acquiring a 2D OOB background image and a 3D entity;
a scene graph renderer generating a 2D foreground image by rendering the 3D entity, and generating a 2D display image according to the 2D background image and the 2D foreground image; and
a display controller directing the display device to display the generated 2D display image.

10. The system of claim 9, further comprising a storage device, wherein the loading unit acquires the 2D OOB background image from an image file of the storage device.

11. The system of claim 9, further comprising a frame buffer, wherein the loading unit duplicates the 2D OOB background image in the frame buffer, the scene graph renderer duplicates the generated 2D foreground image in the frame buffer to form the 2D display image, and the display controller acquires the 2D display image from the frame buffer.

12. The system of claim 11, wherein the scene graph renderer overwrites a portion of the 2D OOB background image of the frame buffer with all or a portion of the 2D foreground image.

13. The system of claim 11, wherein the scene graph renderer blends all or a portion of the 2D foreground image in a portion of the 2D OOB background image.

14. The system of claim 9, further comprising:
a first layer frame buffer; and
a second layer frame buffer,
wherein the loading unit duplicates the 2D OOB background image in the first layer frame buffer, the scene graph renderer duplicates the generated 2D foreground image in the second layer frame buffer, and the display controller acquires the 2D OOB background image from the first layer frame buffer, acquires 2D foreground image from the second layer frame buffer, and generates the 2D display image according to the acquired 2D OOB background image and 2D foreground image.

15. The system of claim 9, wherein the loading unit acquires a 3D rendering file, stores the acquired 3D rendering file in memory, and acquires the 2D OOB background image according to the content of the 3D rendering file.

16. The system of claim 15, wherein the content of the 3D rendering file comprises the 2D OOB background image, and the loading unit acquires the 2D OOB background image from the 3D rendering file.

17. The system of claim 15, wherein the content of the 3D rendering file comprises a filename of an image file storing the 2D OOB background image, and the loading unit acquires the 2D OOB background image from the image file of the storage device according to the filename.

18. The system of claim 15, wherein the 2D OOB background image is stored in read only memory (ROM), and the loading unit acquires the 2D OOB background image from the ROM.

19. A system for computer graphics with out-of-band (OOB) background, comprising:
a display device;
a loading unit acquiring at least two 2D OOB background images and a 3D entity;
a scene graph renderer generating a 2D foreground image by rendering the 3D entity, determining one of the 2D OOB background image according to current time, and generating a 2D display image according to the determined 2D background image and the 2D foreground image; and
a display controller directing the display device to display the generated 2D display image.

20. The system of claim 19, wherein the determined 2D OOB background image is enlarged or reduced to fit storage space of a frame buffer.

21. The system of claim 19, wherein the determined 2D OOB background image is decompressed.
